(19) United States
(12) Patent Application Publication
(10) Pub. No.: US 2005/0068360 A1
(43) Pub. Date: Mar. 31, 2005

(54) Image-forming device in which media is manually inserted and remains stationary during image formation

(76) Inventors: Jeffery Hess, Corvallis, OR (US); Matthew Gelhaus, Albany, OR (US); Rob P. Chohan, San Diego, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/672,761

(22) Filed: Sep. 27, 2003

(51) Int. Cl. B41J 29/38

(52) U.S. Cl. 347/16

(57) ABSTRACT

An image-forming device of one embodiment of the invention is disclosed that includes an image-forming mechanism, a sensor, and a controller. The image-forming mechanism is to form images on media. The mechanism includes a first media path in which media is moved through the mechanism during image formation thereon, and a second media path in which the media is manually inserted and remains stationary within the mechanism during image formation thereon. The media is manually inserted into the image-forming device, and remains stationary within the device during image formation thereon. The sensor is to detect manual insertion of the media, and the controller is to cause the image-forming mechanism to form an image on the media in response to the sensor detecting manual insertion of the media.

### BACKGROUND

Inkjet printers, laser printers, and other types of printers have become popular for printing on media. A printer is more generically an image-forming device that forms images onto media. Printers are usually receptive to a wide variety of media. Because plain paper is most commonly printed on, most users usually load a stack of plain paper into a media tray or drawer of a printer. When the printer outputs a print job, it typically automatically picks up individual sheets of paper from the tray or drawer, and prints on each sheet while moving the sheet through the printer.

For less commonly used media, many printers include a fold-down media tray in which a lesser number of sheets of media can be loaded, as compared to the default media tray or drawer. Envelopes, photo and glossy media, letterhead, and other types of lesser-used media are commonly loaded into this secondary fold-down media tray. The printer again picks up sheets automatically from the secondary tray, and prints on each sheet while moving the sheet through the printer.

However, even with the ability to use a secondary media tray of a printer, many users have found that printing to special types of media, especially envelopes, can be inconvenient. For example, where a user wishes to print a simple return address on an envelope, he or she first has to turn on the computer and wait for it to boot, if the computer is not normally on. The user then has to ensure that envelopes are loaded into the printer, and that they are loaded in the proper orientation. The user finally has to run an application program, such as a word processing program, type in the return address or load the address from a file, and output the print job to the printer.

Because performing these various steps can be time consuming, many users are inclined not to take advantage of the media-handling capabilities their printers offer, and instead resort to handwriting return addresses on envelopes, or use preaddressed labels or rubber stamps instead.

### SUMMARY OF THE INVENTION

An image-forming device of one embodiment of the invention includes an image-forming mechanism, a sensor, and a controller. The image-forming mechanism is to form images on media. The mechanism includes a first media path in which media is moved through the mechanism during image formation thereon, and a second media path in which the media is manually inserted and remains stationary within the mechanism during image formation thereon. The media is manually inserted into the image-forming device, and remains stationary within the device during image formation thereon. The sensor is to detect manual insertion of the media, and the controller is to cause the image-forming mechanism to form an image on the media in response to the sensor detecting manual insertion of the media.

### BRIEF DESCRIPTION OF THE DRAWINGS

The drawings referenced herein form a part of the specification. Features shown in the drawing are meant as illustrative of only some embodiments of the invention, and not of all embodiments of the invention, unless otherwise explicitly indicated.

FIG. 1 is a diagram of a perspective view of a representative image-forming device, according to an embodiment of the invention.

FIGS. 2A, 2B, and 2C are front-view diagrams illustrating the image formation process on media that is manually inserted into an image-forming device and that remains stationary during the process, according to an embodiment of the invention.

FIGS. 3A, 3B, and 3C are cross-sectional side-view diagrams illustrating the image formation process of FIGS. 2A, 2B, and 2C, and correspond to FIGS. 2A, 2B, and 2C, according to an embodiment of the invention.

FIGS. 4A and 4B are cross-sectional side-view diagrams illustrating the image formation process on media that is moved through an image-forming device during the process, according to an embodiment of the invention.

FIGS. 5A and 5B are a front-view diagram and a top-view diagram, respectively, of how image formation by an image-forming device occurs on a swath-by-swath basis, according to an embodiment of the invention.

FIG. 6 is a block diagram of an image-forming device, according to an embodiment of the invention.

FIG. 7 is a flowchart of a method, according to an embodiment of the invention.

### DETAILED DESCRIPTION OF THE DRAWINGS

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, and other changes may be made without departing from the spirit or scope of the present invention. The following detailed description is, therefore, not to be taken in a limiting sense, and the scope of the present invention is defined only by the appended claims.

Image-Forming Device

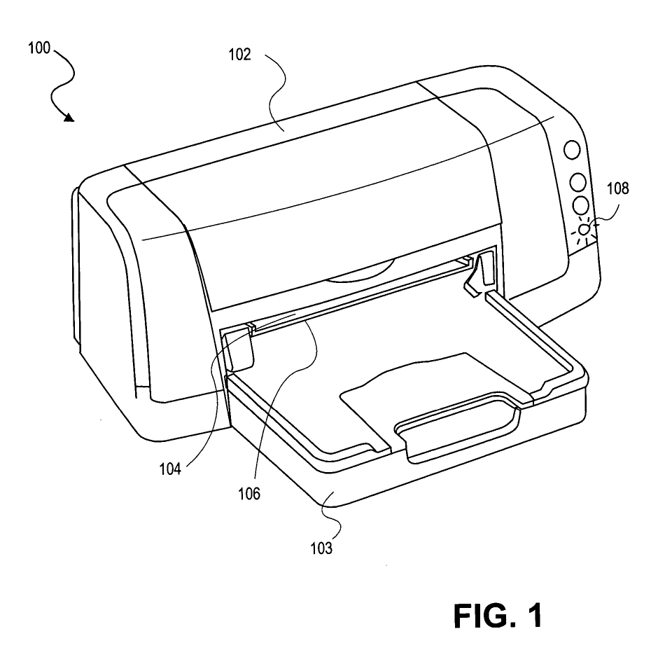

FIG. 1 shows a perspective view of an image-forming device 100, according to an embodiment of the invention. The image-forming device 100 can be an inkjet-printing device, such as an inkjet printer, or another type of printing device that utilizes a different type of image-forming technology. The image-forming device 100 includes a housing 102 within which internal components of the device 100 are disposed. The image-forming device 100 includes a media drawer 103 that contains a supply of media. During regular image formation, the device 100 picks up a sheet of media from the drawer 103, moves it through a media path within the device 100, forms an image on the sheet of media while moving it through the media path, and then outputs the media sheet through the slot 104, or opening, within the housing 102.

In one embodiment of the invention, a user is also able to manually insert media into the slot 104 of the image-forming device 100, guiding the media over the guide 106. The guide ensures proper alignment of the media within the device 100, for aligned image formation on the media. The user may insert the media against an edge of the guide 106 to properly align the media into the slot 104. The guide may include a stop, not explicitly depicted in FIG. 1, that prevents the media from being inserted too far into the slot 104, and that does not affect output of media during regular image formation in which the media is picked up from the drawer 103. The image-forming device 100, after the media has been inserted into the slot 104, forms an image on the part of the media inserted into the slot 104, while the media remains stationary within the device 100.

An indicator 108, such as a light-emitting diode (LED) or another type of light source, lights up to indicate that image formation is complete, such that the user can then manually remove the media from the slot 104 of the image-forming device 100. Alternatively, the indicator 108 may light to signify that image formation has begun, indicating to the user that he or she has inserted the media properly into the slot 104, such that the indicator 108 turns off once image formation has been completed. There may be a short delay before image formation starts after the user has begun to insert the media into the slot 104, so that image formation does not begin until after the user has completely inserted the media into the slot 104.

The image that is formed on the portion of the media manually inserted into the slot 104 of the image-forming device 100 can in one embodiment be a return address, where the media that is manually inserted into the slot 104 is an envelope. The return address may be stored internally within the image-forming device 100. This means that the user does not have to turn on a host computing device, such as a desktop or a laptop computer, that may be communicatively connected to the device 100 to print the return address on the envelope. So long as the image-forming device 100 is on, media can be manually inserted into the slot 104 for image formation thereon while the media remains stationary within the image-forming device 100, regardless of whether a host device is even present.

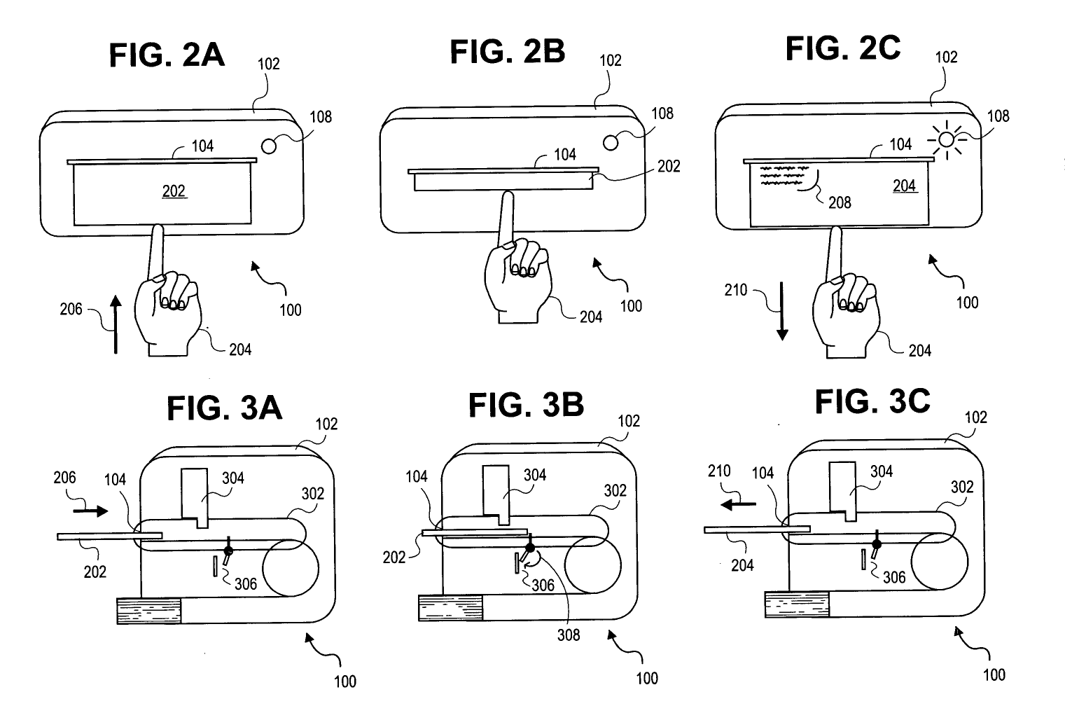

FIGS. 2A-2C and 3A-3C illustratively depict the image formation process on stationary media that has been manually inserted into the image-forming device 100, according to an embodiment of the invention. FIGS. 2A-2C depict the image formation process from the front view of the image-forming device 100, whereas FIGS. 3A-3C depict the process from a cross-sectional side view of the image-forming device 100. Like-lettered figures of FIGS. 2A-2C and 3A-3C represent the same step or act of the process. For instance, FIGS. 2A and 3A represent the first step or act of the process, FIGS. 2B and 3B represent a middle step or act of the process, and FIGS. 2C and 3C represent the last step or act of the process.

In FIGS. 2A and 3A, the user 204 is manually inserting envelope media 202 into the slot 104 of the housing 102 of the image-forming device 100, as indicated by the arrow 206. The slot 104 exposes a media path 302 within the image-forming device 100 for manual insertion of the media 202 within the device 100. A printhead 304 is disposed within the housing 102 of the image-forming device 100, which is a part of an image-forming mechanism of the device 100. A freely rotating switch 306 is also disposed within the housing 102 of the image-forming device 100.

In FIGS. 2B and 3B, the user 204 has inserted the envelope media 202 into the slot 104 of the housing 102 of the image-forming device 100. The media 202 thus has been inserted into the media path 302, such that a portion of the media 202 lies underneath, or adjacent to, the printhead 304. Manual insertion of the media 202 has caused the freely rotating switch 306 to be actuated, as indicated by the arrow 308. The switch 306 detects insertion of the media 202, and as a result the image-forming device 100 forms an image on the media 202. Specifically, the printhead 304 moves across the media 202 one or more times to form an image thereon, such as a return address. The movement of the printhead 304 in FIG. 3B is in and out of the plane of FIG. 3B. The media 202 remains stationary while the printhead 304 moves and forms an image on the media 202.

The switch 306 may have an arm attached to the top thereof, not specifically depicted in FIGS. 2B and 3B, to prevent the media 202 from being inserted too far into the slot 104. In addition, the switch 306 may be an optical switch, instead of a mechanical switch as depicted in FIGS. 2B and 3B, such that no physical contact results between media and the switch 306. Furthermore, once the media 202 has been properly inserted into the slot 104, an optional clamping mechanism, not specifically depicted in FIGS. 2B and 3B may clamp down and hold the media 202 during image formation thereon.

In FIGS. 2C and 3C, the user 204 is alerted by the indicator 108 of the image-forming device 100 turning on, such that the user 204 can now manually remove the media 202 from the slot 104 of the housing 102 of the image-forming device 100, as indicated by the arrow 210. An image 208 has been formed on the media 202. In removing the media 202 from the image-forming device 100, the user removes the media 202 from the media path 302 and from under the printhead 304, such that the switch 306 is no longer actuated.

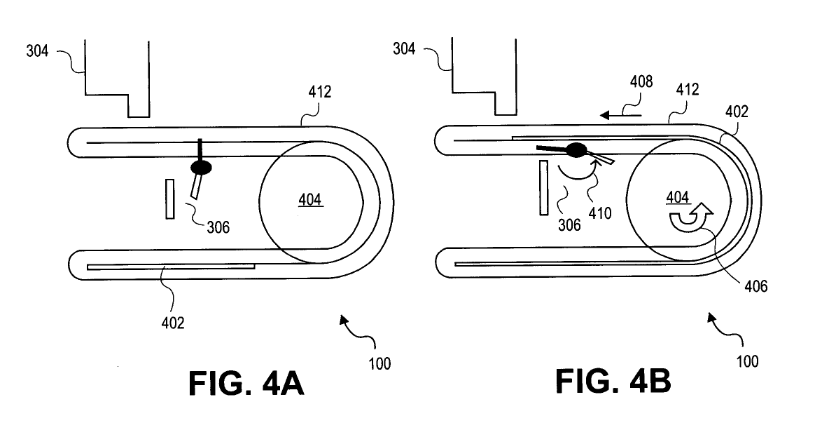

FIGS. 4A and 4B show a cross-sectional side view of the image-forming device 100 when the device 100 is being used to form images on media 402 loaded from the drawer 103 of FIG. 1, according to an embodiment of the invention. Another media path 412 is defined in which paper media 402, or another type of media loaded from the drawer 103, can be moved through the image-forming device 100, around a roller 404, and under the printhead 304. The roller 404 is part of a media-moving mechanism of the image-forming device 100. The image-forming device 100 again includes the freely rotating switch 306.

In FIG. 4A specifically, the paper media 402 has begun to be moved through the media path 412 of the image-forming device 100. In FIG. 4B specifically, the roller 404, by its rotating action as indicated by the arrow 406, rotates the paper media 402 through the media path 412 and under the printhead 304, as indicated by the arrow 408. The freely rotating switch 306 is rotated out of the way, as indicated by the arrow 410, such that the switch 306 is not actuated during movement of the media 402 through the media path 412 and does not significantly affect the movement of the media 402. That is, the switch 306 does not significantly affect or impinge on the media 402 during regular image formation, in which the media 402 is picked up from the drawer 103 of FIG. 1.

Image formation is accomplished on a swath-by-swath basis by the printhead 304 of the image-forming device 100. That is, a swath, or portion, of the media 402 is moved under the printhead 304, which moves over the swath of the media 402 to form part of an image onto the media 402. The media 402 is again automatically moved to expose the next swath of the media 402 under the printhead 304, and the printhead 304 forms another part of the image onto this swath of the media 402. This process is repeated until an image has been completely formed on the media 402. That is, image formation on the media 402 is accomplished in the process illustratively depicted in FIGS. 4A and 4B while the media 402 is moving through the image-forming device 100.

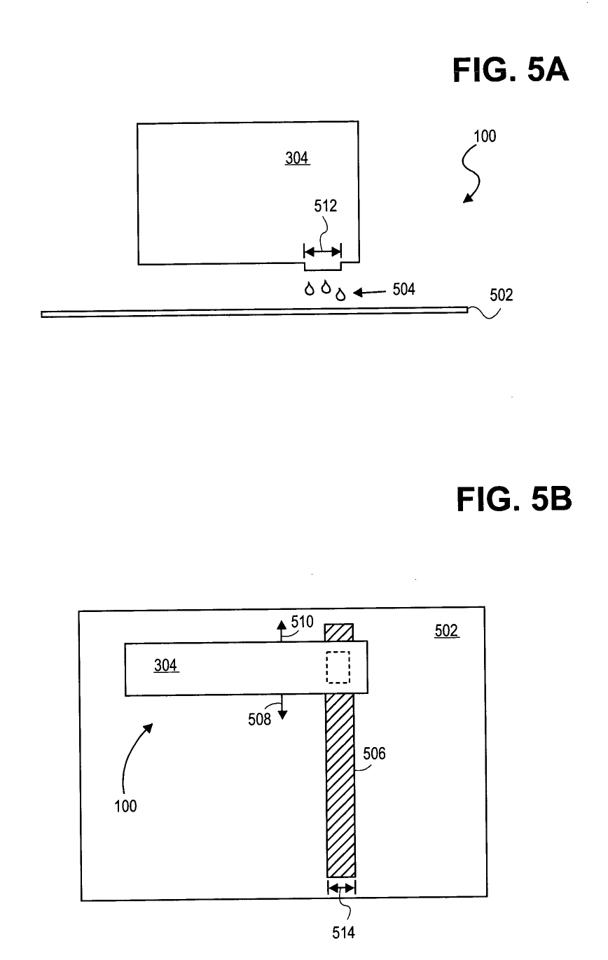

FIGS. 5A and 5B illustratively depict image formation by the image-forming device 100 on a swath-by-swath basis, according to an embodiment of the invention. FIG. 5A is a front view of the image formation process, whereas FIG. 5B is a top view of the process. The printhead 304 of the image-forming device 100 is shown in FIGS. 5A and 5B, and no other components of the device 100 are shown for illustrative clarity. The printhead 304 is specifically an inkjet printhead 304 in one embodiment of the invention, such as an ink-ejection printhead, which ejects ink 504 to form an image on the media 502 on a swath by swath basis.

In FIG. 5A specifically, the printhead 304 has a print height 512, which is the distance over which it is able to eject ink 504 at a given time. In FIG. 5B specifically, the printhead 304 moves over a swath 506 of the media 502, as indicated by the arrows 508 and 510. The printhead 304 ejects ink as it moves over the swath 506 of the media 502 such that the swath 506 has a height 514 corresponding to the height 512 of the printhead 304 shown in FIG. 5A.

Where the media 502 is inserted into the media path 302 of FIGS. 3A-3C through the slot 104 of the image-forming device 100, the media 502 remains stationary during the image formation process. This means that the image formed on the media 502 has a height corresponding to the height 514 of the media swath 506 and the height 512 of the printhead 304, because the media 502 remains stationary during the complete image formation process.

By comparison, where the media 502 is moved through the media path 412 of FIGS. 4A-4B of the image-forming device 100, such that the media 502 is picked up from the drawer 103 of FIG. 1 instead of being manually inserted into the slot 104 of FIG. 1, the media 502 moves during the image formation process. This means that after the printhead 304 has ejected ink onto the media swath 506, the media 502 is moved to expose a different media swath under the height 512 of the printhead 304, and the printhead 304 ejects ink onto this new media swath. This process repeats until an image has been completely formed on the media 502. Because the image is formed on a swath-by-swath basis, the media 502 is moved so that each media swath of the media 502 can have ink ejected onto it as appropriate.

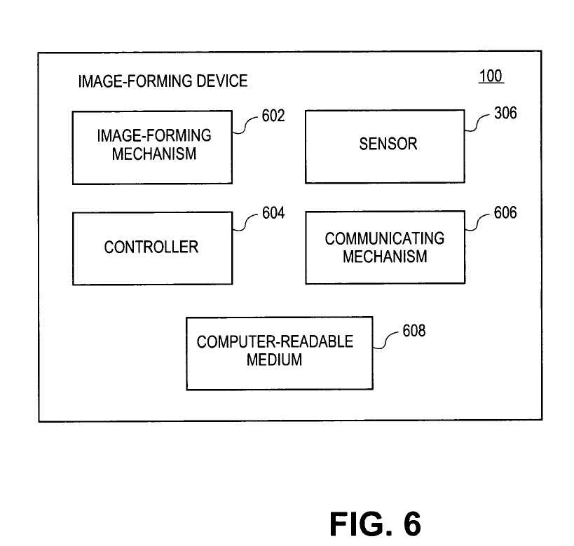

FIG. 6 shows a block diagram of the image-forming device 100, according to an embodiment of the invention. As can be appreciated by those of ordinary skill within the art, the image-forming device 100 can include other components, in addition to and/or in lieu of those depicted in FIG. 6. The image-forming device 100 is shown in FIG. 6 as including an image-forming mechanism 602, a sensor 306, a controller 604, a communications mechanism 606, and a computer-readable medium 608.

The image-forming mechanism 602 includes those components of the image-forming device 100 that enable images to be formed onto media. For instance, the image-forming mechanism 602 may include the printhead 304 that has been described. In one embodiment, the image-forming mechanism 602 is an inkjet-printing mechanism, such that the image-forming device 100 is an inkjet-printing device. The sensor 306 detects manual insertion of media into the image-forming device 100, where such media remains stationary within the device 100 during image formation thereon by the image-forming mechanism 602. That is, the sensor 306 detects positioning of the media adjacent, such as under, the image-forming mechanism 602. In one embodiment, the sensor 306 is the switch 306 that has been described.

The controller 604 may be hardware, software, or a combination of hardware and software. The controller 604 may be disposed within the housing 102 of FIG. 1. The controller 604 causes the image-forming mechanism 602 to form an image on the media manually inserted into the image-forming device 100, in response to the sensor 306 detecting manual insertion of the media into the device 100. The communications mechanism 606 includes those components of the image-forming device 100 that enables the device 100 to communicate with, or communicatively couple to, a host computing device, such as a desktop or a laptop printer. The communications mechanism 606 may provide for a wired or a wireless connection with the host device.

The computer-readable medium 608 may be a non-volatile medium, such as a non-volatile semiconductor or magnetic medium. The medium 608 can store the image that is to be formed on the media manually inserted into the image-forming device 100. This image may initially be entered by the user on the host computing device communicatively coupled to the image-forming device 100 via the communications mechanism 606. Thereafter, the image is stored on the medium 608, such that the host device does not have to be on or connected to the image-forming device 100, for the device 100 to be able to form the image on the media manually inserted into the image-forming device 100. Alternatively, the image-forming device 100 itself may include an input mechanism that allows the user to enter the image to be formed on the media manually inserted into the device 100, such as textual data entered on a rudimentary keyboard or set of controls of the device 100.

The image may thus be a predetermined static image that, once stored on the computer-readable medium 608 of the image-forming device 100, does not normally vary on an image formation job-by-image formation job basis. An example of such a static image is a return address, which once set by the user, does not normally change. Alternatively, however, the image may be a dynamic image that is able to be varied for each image formation job. Such an image may be received from the host computing device to which the image-forming device 100 is communicatively coupled via the communications mechanism 606. Alternatively, an input mechanism of the device 100 may enable the user to vary the image on an image formation job-by-image formation job basis, without use of a host device. Examples of such dynamic images include recipient addresses, which typically vary for each envelope manually inserted into the device 100, as well as barcodes, and other types of dynamic images.

### Method and Conclusion

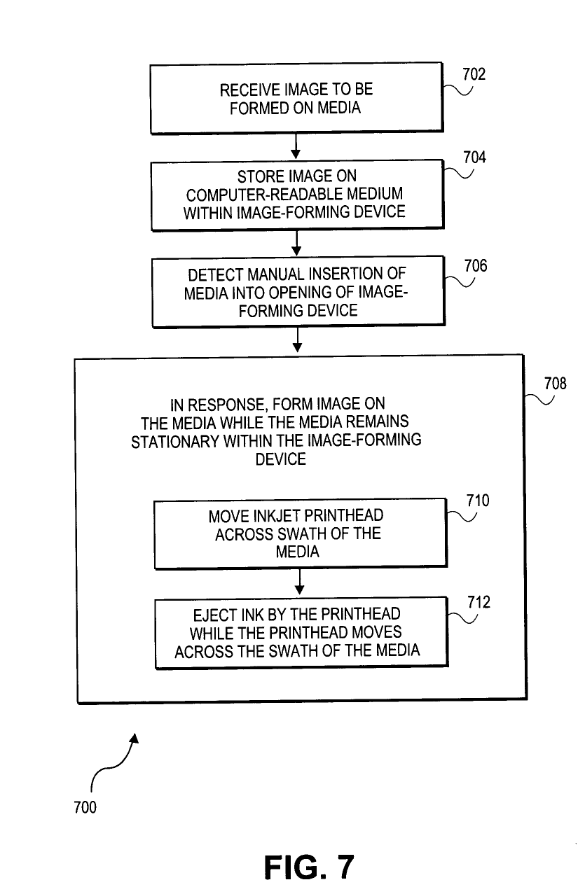

FIG. 7 shows a method 700 for forming an image on media that is manually inserted and remains stationary during the image formation process, according to an embodiment of the invention. The method 700 can be performed by, and is described in relation to, the image-forming device 100 that has been described in the previous section of the detailed description. First, the image-formation device 100 receives the image that is to be formed on the media (702). The image may be received, for instance, from a host computing device communicatively coupled to the image-forming device 100. The image is then stored on the computer-readable medium 608 within image-forming device 100 (704), so that the image can be formed on media without the device 100 having to be communicatively coupled to the host device.

The user inserts media into an opening, such as the slot 104, of the image-forming device 100, such that this manual insertion of the media into the opening is detected (706). Detection may be accomplished by manual insertion of the media causing actuation of the switch 306 that has been described. In response, the image-forming device 100 forms an image on the media while the media remains stationary within the device (100). For example, this can be accomplished by the image-forming device 100 having an inkjet printhead 304 that is part of the image-forming mechanism 602 of the device 100. The printhead 304 thus moves across a swath of the media (710). While the printhead 304 moves across the media, it ejects ink on the swath (712).

It is noted that, although specific embodiments have been illustrated and described herein, it will be appreciated by those of ordinary skill in the art that any arrangement calculated to achieve the same purpose may be substituted for the specific embodiments shown. This application is intended to cover any adaptations or variations of the disclosed embodiments of the present invention. Therefore, it is manifestly intended that this invention be limited only by the claims and equivalents thereof.

1. An image-forming device comprising:
an image-forming mechanism to form images on media, the media manually inserted into the image-forming device and remaining stationary within the image-forming device during image formation thereon, the mechanism including a first media path in which media is moved through the mechanism during image formation thereon and a second media path in which the media is manually inserted and remains stationary within the mechanism during image formation thereon;
a sensor to detect manual insertion of the media; and,
a controller to cause the image-forming mechanism to form an image on the media in response to the sensor detecting manual insertion of the media.

2. The image-forming device of claim 1, wherein the second media path extends to under a printhead of the image-forming mechanism, such that manual insertion of the media within the second media path places the media under the printhead, where the media remains stationary while the printhead forms the image thereon.

3. The image-forming device of claim 1, wherein the sensor comprises a freely rotating switch that is actuated by the media being manually inserted within the second media path, and that is rotated out of the way by the media moving through the image-forming mechanism within the first media path.

4. The image-forming device of claim 1, further comprising a housing within which the image-forming mechanism, the sensor, and the controller are disposed, the housing defining a slot that exposes the second media path of the image-forming device.

5. The image-forming device of claim 4, further comprising a guide situated on the housing to guide manual insertion of the media into the slot and within the second media path for aligned image formation of the image on the media.

6. The image-forming device of claim 1, wherein the image-forming mechanism comprises a printhead that is able to move across media to form images thereon, the printhead having a print height corresponding to a swath of media such that the printhead forms images on the media on a swath-by-swath basis.

7. The image-forming device of claim 7, wherein the image formed by the image-forming mechanism on the media manually inserted is one swath of media in height.

8. The image-forming device of claim 7, wherein the printhead is an ink-jet printhead ejecting ink to form images on media, such that the image-forming device is an inkjet-printing device.

9. The image-forming device of claim 1, wherein the image to be formed by the image-forming mechanism on the media manually inserted is a predetermined static image that does not normally vary on an image formation job-by-image formation job basis.

10. The image-forming device of claim 1, wherein the image to be formed by the image-forming mechanism on the media manually inserted is a dynamic image that is able to be varied on an image formation job-by-image formation job basis.

11. The image-forming device of claim 1, further comprising a computer-readable medium to store the image to be formed by the image-forming mechanism on the media manually inserted, such that the image is able to be formed on the media manually inserted without the image-forming device having to be communicatively coupled to a host computing device.

12. The image-forming device of claim 1, further comprising a communications mechanism to communicatively couple the image-forming device with a host computing device to at least initially receive the image to be formed by the image-forming mechanism on the media manually inserted.

13. The image-forming device of claim 1, wherein the media to be manually inserted is an envelope, and the image to be formed on the media manually inserted is a return address.

14. The image-forming device of claim 1, wherein the image to be formed on the media manually inserted is a barcode.

15. An image-forming device comprising:
an image-forming mechanism to form images on media;
a housing within which the image-forming mechanism is disposed and defining an opening into which media is manually inserted such that the media is positioned stationary and adjacent to the image-forming mechanism;
a sensor to detect positioning of the media adjacent to the image-forming mechanism; and,
a controller to cause the image-forming mechanism to form an image on the media inserted into the opening of the housing in response to the sensor detecting positioning of the media adjacent to the image forming mechanism.

16. The image-forming device of claim 15, wherein the image-forming mechanism comprises an inkjet printhead that is able to move across the media to eject ink thereon, the printhead having a print height corresponding to a swath of media such that the image formed by the image-forming mechanism on the media manually inserted within the image-forming device is one swath of media in height.

17. The image-forming device of claim 15, further comprising a computer-readable medium to store the image to be formed by the image-forming mechanism on the media manually inserted within the opening of the housing, such that the image is able to be formed on the media manually inserted within the opening of the housing without the image-forming device being communicatively coupled to a host computing device.

18. The image-forming device of claim 15, further comprising a communications mechanism to communicatively couple the image-forming device with a host computing device to at least initially receive the image to be formed by the image-forming mechanism on the media manually inserted within the opening of the housing.

19. The image-forming device of claim 15, further comprising a guide situated on the housing to guide manual insertion of the media into the opening of the housing for aligned image formation of the image on the media.

20. An image-forming device comprising:
an image-forming mechanism to form images on media; and,
means for causing the image-forming mechanism to form an image on media manually inserted into and subsequently remaining stationary within the image-forming device during image formation thereon.

21. The image-forming device of claim 20, wherein the image-forming mechanism comprises an inkjet printhead that is able to move across the media to eject ink thereon, the printhead having a print height corresponding to a swath of media such that the image formed by the image-forming mechanism on the media manually inserted within the image-forming device is one swath of media in height.

22. The image-forming device of claim 20, wherein the means comprises:
means for detecting manual insertion of the media within the image-forming device; and,
means for causing the image-forming device to form the image on the media manually inserted into the image-forming device in response to the sensing means detecting manual insertion of the media therein.

23. A method comprising:
detecting manual insertion of media into an opening of an image-forming device; and,
in response to detecting the manual insertion of the media into the opening of the image-forming device, forming an image on the media while the media remains stationary within the image-forming device.

24. The method of claim 23, wherein detecting the manual insertion of the media into the opening of the image-forming device comprises the manual insertion of the media causing actuation of a switch that results in detection of the manual insertion of the media into the opening of the image-forming device.

25. The method of claim 23, wherein forming the image on the media while the media remains stationary within the image-forming device comprises:
moving an inkjet printhead across a swath of the media; and,
ejecting ink by the inkjet printhead while the inkjet printhead moves across the swath of the media, to form the image on the media.

26. The method of claim 23, further comprising initially receiving the image to be formed on the media while the media remains stationary within the image-forming device.

27. The method of claim 26, wherein initially receiving the image to be formed on the media comprises communicating with a host computing device communicatively coupled to the image-forming device to receive the image therefrom.

28. The method of claim 26, further comprising storing the image on a computer-readable medium within the image-forming device so that the image is able to be formed on the media without the image-forming device having to be communicatively coupled to a host computing device.
